(19) United States
(12) Patent Application Publication
(10) Pub. No.: US 2004/0216159 A1
(43) Pub. Date: Oct. 28, 2004

(54) Method and apparatus for synchronizing co-cast content with viewering habits

(76) Inventor: Fathy Yassa, Soquel, CA (US)

Correspondence Address: Fathy Yassa, 4439 Esta Lane, Soquel, CA, 95073, US

(21) Appl. No.: 10/776,624

(22) Filed: Jan. 20, 2004

Related U.S. Application Data
(60) Provisional application No. 60/441,672, filed on Jan. 21, 2003.

(51) Int. Cl. H04N 7/025; G06F 3/00; H04N 7/10; H04N 5/445; G06F 13/00

(52) U.S. Cl. 725/46; 725/34; 725/35

(57) ABSTRACT

A method and apparatus designed to permit content distributors to insert personalized content into a media stream or television signal based upon the user preferences or viewing habits.

### CLAIM OF PRIORITY

This Application claims priority from U.S. PTO provisional application No. 60/441,672 filed on Jan. 21, 2003, and incorporates said application by reference as if fully set forth herein.

### BACKGROUND OF THE INVENTION

1. Technical Field

The invention herein discloses an exemplary method and apparatus for dynamically delivering content to a viewer upon his television viewing habits.

2. Description of the Prior Art

Currently, the majority of television program distributors, whether cable, broadcast or satellite, encode a small portion of the television signal with identification (index) data. In analog television the region used is known as the vertical blanking interval. The vertical blanking interval (VBI) is a portion of a television signal that can carry information other than video or audio, such as closed-caption text and stock market data. The interval in sending a video signal is required for the time it takes the electron gun in a television monitor's cathode ray tube (CRT) to move back up to the top of the tube. VBI data can be inserted by a content provider and transmitted to a special receiver that connects to a computer. In digital television, MPEG2 data streams offer a similar capacity for inserting Internet data alongside the audio and video information. This unused region of the television signal can occupy significant bandwidth, upwards of 96 kilobits per second (Kbps), roughly twice as fast the best dial-up modems.

These unused regions have been tapped to carry index data may include channel number, closed captioning data, time playing, VCR+ information, program identification, etc. Since the encoded data does not occupy any portion of the content data, there is no degradation of the content quality.

Content distributors have not used this data to increase revenue models or personalization substantially beyond the traditional pay per view model. In a traditional pay per view system, the content is transmitted in a format unreadable by most television sets. However, an authorized set-top box can descramble the content. The content distributor embeds within the unused portion of the video signal permission for the set-top box to descramble the content.

Besides pay per view, some content distributors use a bi-directional set top box to report the viewing habits of its customers. However, that information is generally used in the aggregate, to determine what types of content to distribute to the customers as a whole, rather marketing to individual customers. Alternatively, this information may be used for off-line solicitations, i.e. sold to third parties who then solicit the customer via traditional means such as telephone and direct marketing.

For purposes of this invention, a television signal refers to any electromagnetic signal capable of carrying audio or video data. Similarly, for purposes of this invention, a set top box includes a traditional set top box configured to send and receive television signals and internet data, as well as a set top box enhanced with one or more features including, mass storage capabilities such as hard drive, optical drives, compact flash, etc. as well as content time shifting such as Tivo™ or Replay-TV™.

The present invention is unique and exemplary in that it permits advertisers, content distributors, etc. to use the end-users television viewing habits to personalize the on-line distribution of content. For purposes of this disclosure on-line distribution of content means the dynamic and immediate delivery of personalized content via electronic means. For example, an advertiser may send wireless ads to an end-user whose television viewing habits suggest a particular receptivity to the goods or services provided. Similarly, a content provider might send certain types of content to the end-user based upon the current television show being watched. Therefore it is necessary for the invention to determine the viewing habits of each end-user as well as the current television show being watched.

### SUMMARY OF THE INVENTION

The current invention represents a method and apparatus for delivering personalized content to an end-user. This invention determines the television viewing habits of the end-user and inserts content into the non-visual portion of the television signal which is then transmitted to the end user's wireless device, computer system, or television.

### BRIEF DESCRIPTION OF THE FIGURES

FIG. 1 is a block diagram of a first embodiment of the overall invention.

FIG. 2 is a flow diagram of one embodiment of the overall invention.

FIG. 3 is a block diagram of a second embodiment of the invention.

FIG. 4 is a flow diagram of a second embodiment of the invention.

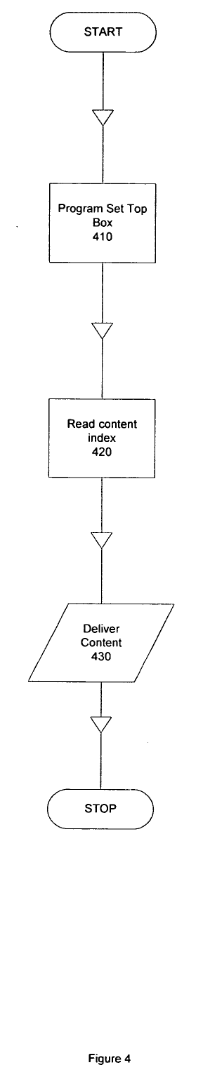

### DETAILED DESCRIPTION

The present invention consists of a smart set-top box configured to read index data from a television signal, with internet connectivity, computer software, and wireless connectivity.

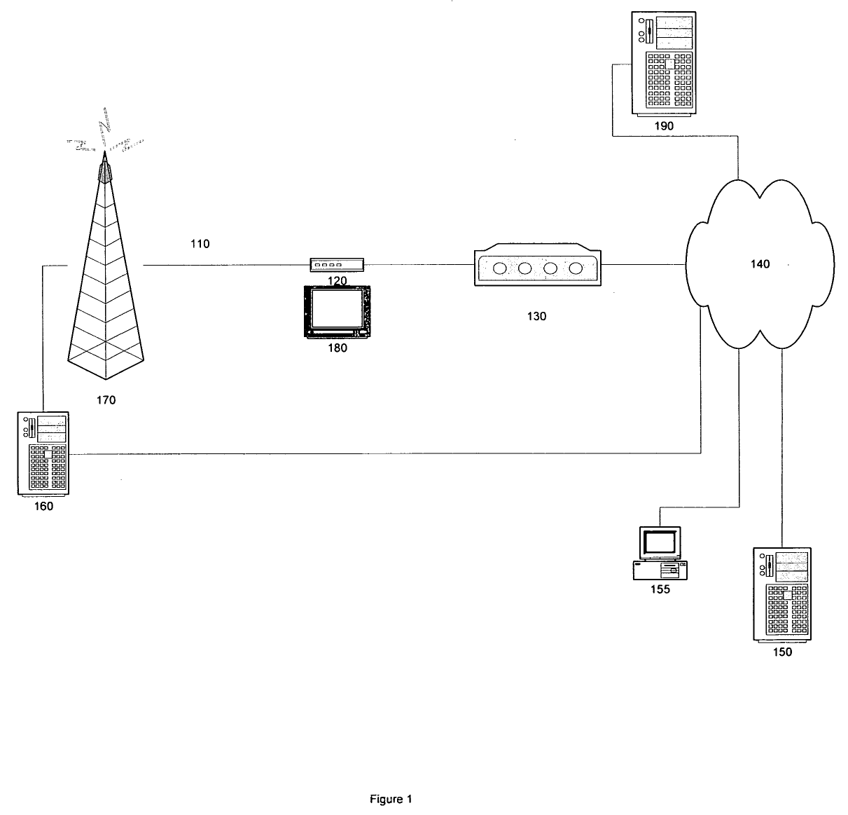

Referring to FIG. 1, in one embodiment of the present invention, set-top box 120 reads the index data from television signal 110 to determine what television show(s) the end-user is watching. This information is then sent via communication means 130 to server 150, via the internet 140, for storage and processing. Server 150 collates each user's viewing habits and sends said information to content distributor's server 160 which inserts content back into the television signal through transmission means 170 along with sufficient destination information. Set top box 120 reads the index information and pulls out the appropriate content and displays it for the end-user on one or more receiving devices 180. Server 150 also combines the viewing habits with personally identifiable information and sends said information to marketing server 190 via the internet 140.

In another embodiment of the invention, content distributor's server 160 e-mails content to the end-user's web-enabled device.

In another embodiment, instead of set top box learning the user's habits, the user chooses what types of content to receive. User Computer 155 transmits the viewing preferences to content distributor server 160, via internet 140, to determine which content is included based upon the user preferences.

In yet another embodiment, of the invention, content distributor 160 sends content to set top box 120, via the public internet 140.

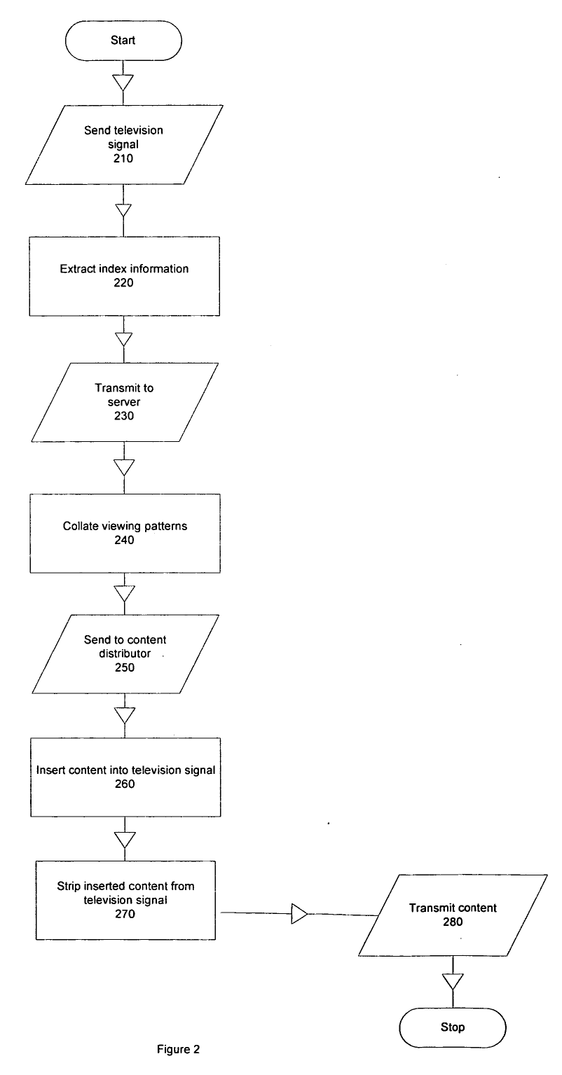

Referring to FIG. 2, in one embodiment of the invention, at step 210 the content distributor sends a television signal to the set top box residing in the end-user's home. At step 220, the set top box extracts the index information and at step 230 sends it to a server configured to collate the index information at step 240 to determine the viewing habits of each subscriber. The server transmits its findings back to the content distributor at step 250. At step 260, the content distributor uses these findings to insert additional content into the normally non-viewable portion of the television signal which is still being transmitted to set top box. At step 270 the set-top box strips the content from the non-viewable portion of the television signal along with any instructions and at step 280 transmits the content according to said instructions.

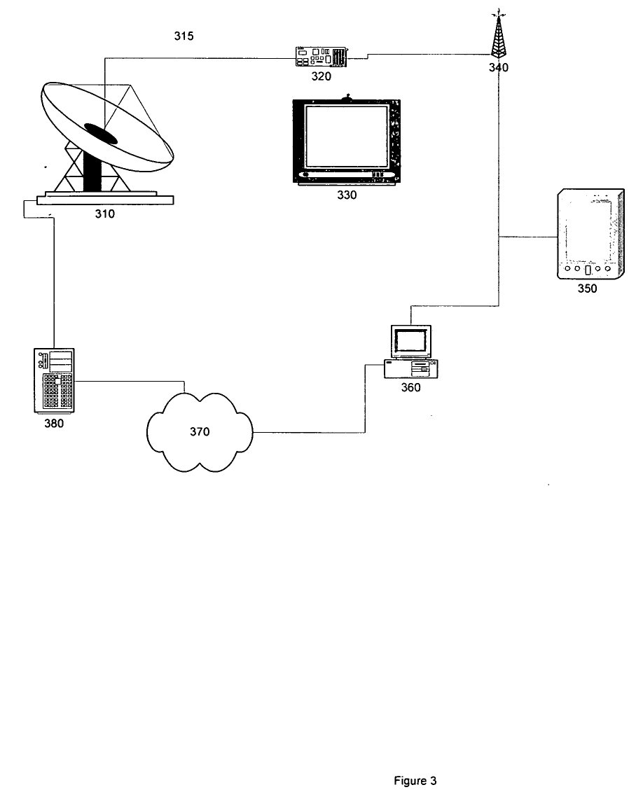

Referring to FIG. 3, Content distributor 310 transmits television signal 315 to set top box 320. Said television signal includes within the non-viewable portion, index information regarding current content viewed, as well as additional content placed in by advertisers, content producers, etc. Set top box 320 reads the index information and collates the information to determine the viewing habits. Set top box 320 reads the additional content and transmits it via transmitter 340 to television 330 or wireless device 350. Transmitter 340 may be built into set top box 320 or may be a separate transmittal unit.

1. A method of co-casting personalized content via an analog or digital television signal to a viewer based upon the viewer's preferences comprising the steps of determining the user's viewing preferences, reading portion of the non-viewable television signal; and transmitting the appropriate co-cast content to the user.

2. The step of claim 1 where the user's viewing preferences are programmed into a computer and sent to the user's set top box

3. The step of claim 2 where the set top box determines the user's preferences by collating the index data from the television signal.

4. The step of claim 3 where the data collation occurs in the set top box.

5. The step of claim 3 where the set top box transmits the index data for collation by an external computer server.

6. The step of claim 3, where the content provider inserts personalized content into the television signal.

7. The step of claim 3, where the content provider sends personalized content to the set top box via the internet.

8. The step of claim 1 where the set top box transmits content to a wireless device.

9. The step of claim 1 where the set top box e-mails content to any web-enabled device.

10. The step of claim 1 where the set top box transmits content to the television set during the commercial breaks, in lieu of the commercial.
